(19) United States
(12) Patent Application Publication
(10) Pub. No.: US 2013/0258152 A1
(43) Pub. Date: Oct. 3, 2013

(54) CAMERA DEVICE FOR ACQUIRING STEREO IMAGES WITH ONE SENSOR

(71) Applicants: Vadim BALANNIK, Arlington Heights, IL (US); Patrick Dell ELLIS, Lake in the Hillls, IL (US); John Ivan SCHARKOV, Toronto (CA)

(72) Inventors: Vadim BALANNIK, Arlington Heights, IL (US); Patrick Dell ELLIS, Lake in the Hillls, IL (US); John Ivan SCHARKOV, Toronto (CA)

(73) Assignee: RESEARCH IN MOTION LIMITED, Waterloo (CA)

(21) Appl. No.: 13/432,995

(22) Filed: Mar. 28, 2012

(51) Int. Cl. H04N 5/335; H04N 5/225

(52) U.S. Cl. 348/308; 348/340; 348/E05.024; 348/E05.091

(57) ABSTRACT

A camera device for acquiring stereo images with one sensor is provided. The camera comprises: two apertures in a housing of the camera device, the two apertures separated by a human interocular distance; a sensor for sequentially acquiring electronic images from each of the two apertures; at least one minor enabled to change state for sequentially directing light from each of the two apertures to the sensor; and a controller for synchronizing the sensor with the state of the at least one mirror such that a first electronic image is acquired at the sensor from a first one of the two apertures when the at least one mirror is in a first state and a second electronic image is acquired at the sensor from the other of the two apertures when the at least one minor is in a second state.

### FIELD

The specification relates generally to camera devices, and specifically to a camera device for acquiring stereo images with one sensor.

### BACKGROUND

Acquiring stereo images at a camera device generally involves two image sensors, one for each of the two images. However, such sensors are expensive and can hence drive up the cost of a stereo camera.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIGS. 1A and 1B depict front and rear views of a camera device for acquiring stereo images with one sensor, according to non-limiting implementations.

FIG. 2 depicts a schematic diagram of the camera FIG. 1, according to non-limiting implementations.

FIG. 3 depicts the camera device of FIG. 2 with a mirror in a first state for directing light from a first aperture to a sensor, according to non-limiting implementations.

FIG. 4 depicts the camera device of FIG. 2 with a minor in a second state for directing light from a second aperture to a sensor, according to non-limiting implementations.

FIG. 5 depicts a schematic diagram of a camera device for acquiring stereo images, according to non-limiting implementations.

FIG. 6 depicts the camera device of FIG. 5 with a mirror in a first state for directing light from a first aperture to a sensor, according to non-limiting implementations.

FIG. 7 depicts the camera device of FIG. 5 with a mirror in a second state for directing light from a second aperture to a sensor, according to non-limiting implementations.

FIG. 8 depicts a schematic diagram of a camera device for acquiring stereo images, according to non-limiting implementations.

FIG. 9 depicts the camera device of FIG. 8 with a mirror in a first state for directing light from a first aperture to a sensor, according to non-limiting implementations.

FIG. 10 depicts the camera device of FIG. 8 with a mirror in a second state for directing light from a second aperture to a sensor, according to non-limiting implementations.

FIG. 11 depicts a schematic diagram of a camera device for acquiring stereo images, according to non-limiting implementations.

FIG. 12 depicts the camera device of FIG. 11 with a minor in a first state for directing light from a first aperture to a sensor, according to non-limiting implementations.

FIG. 13 depicts the camera device of FIG. 11 with a mirror in a second state for directing light from a second aperture to a sensor, according to non-limiting implementations.

### DETAILED DESCRIPTION

An aspect of the specification provides a camera device comprising: two apertures in a housing of the camera device, the two apertures separated by a human interocular distance; a sensor for sequentially acquiring electronic images from each of the two apertures; at least one mirror enabled to change state for sequentially directing light from each of the two apertures to the sensor; and a controller for synchronizing the sensor with the state of the at least one minor such that a first electronic image is acquired at the sensor from a first one of the two apertures when the at least one minor is in a first state and a second electronic image is acquired at the sensor from the other of the two apertures when the at least one mirror is in a second state.

The two apertures can be separated by a distance in a range of approximately 58 mm to approximately 71 mm.

The sensor can comprise a CMOS (Complementary metal-oxide-semiconductor) image sensor or a CCD (charge-coupled device) image sensor.

The camera device can further comprise a system of minors for directing light from the two apertures to the sensor, wherein the system of minors can comprise the at least one mirror.

The at least one minor can be enabled to change the state by one or more of rotating and moving from a first position to a second position. The at least one minor can comprise one or more of a prism device, a micromirror device, a digital micromirror device (DMD) and a microelectromechanical system (MEMS) device.

The sensor can be located midway between the two apertures. The camera device can further comprise respective minors behind each of the two apertures to direct the light to the at least one mirror, the at least one minor located in front of the sensor.

The at least one mirror can be enabled to change states by moving from directing the light from a first one of the respective minors to the sensor in the first state to directing the light from a second one of the respective mirrors in the second state.

The at least one minor can be enabled to change the state by switching between a reflective state and a transmissive state. The at least one mirror can comprise one or more of an electro-optic device and an electro-chromic device.

The sensor can be located behind a given one of the two apertures. The camera device can further comprise a second minor located behind the other of the two apertures to direct the light to the at least one minor, the at least one mirror between the sensor and the given one of the two apertures. The at least one mirror can be enabled to change states moving between being out of a path between the given one of the two apertures and the sensor in the first state, and into the path to direct the light from the other of the two apertures and the second mirror to the sensor in the second state. The camera device can further comprise a lens at one of the two apertures to correct for a difference in path length from each of the two apertures to the sensor. The at least one mirror can be enabled to change states by changing between a transmissive state, such that the light from the given one of the apertures is directed from the given one of the apertures through the at least one minor to the sensor in the first state, and a reflective state such that light from other of the two apertures and the second mirror is directed to the sensor in the second state.

The camera device can further comprise an apparatus for changing the state of the at least one minor by changing position of the at least one mirror.

The camera device can further comprise a processor, which in turn can comprise the controller, the processor in communication with the sensor and an apparatus for changing the state of the at least one mirror.

The camera device can further comprise a memory for storing the electronic images acquired by the sensor.

Sequential electronic images can be acquired by the sensor when the at least one minor is in the first state and the second state are stored in association with each other such that they can be later viewed as a stereo image.

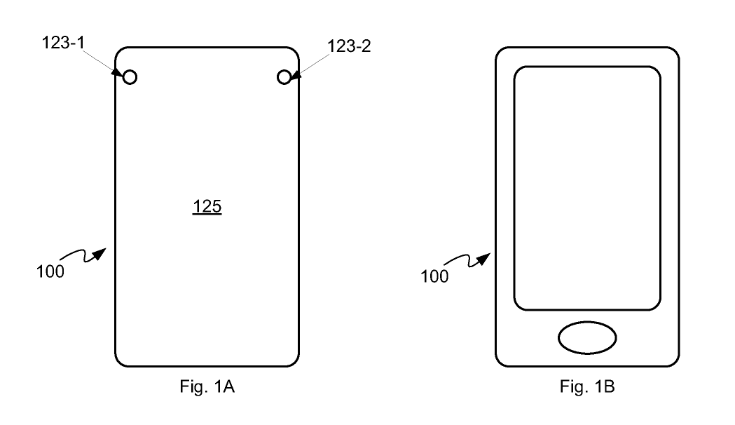

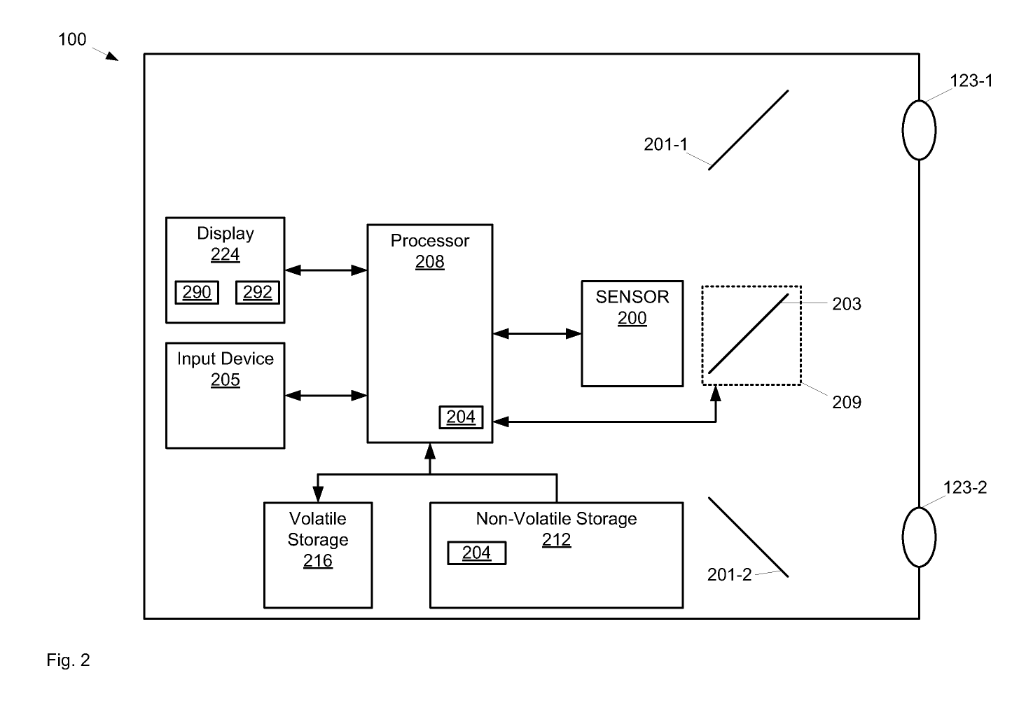

FIGS. 1A and 1B depict front and rear views, respectively, of a camera device 100 for acquiring stereo images with one sensor, while FIG. 2 depicts a schematic diagram of camera device 100, according to non-limiting implementations. Camera device 100 will also be referred to hereafter as camera 100. Camera 100 is generally enabled to acquire stereo images via each of two apertures 123-1, 123-2 in a housing 125 of the camera device. Apertures 123-1, 123-2 will also be referred to hereafter collectively as apertures 123 and generically as an aperture 123. This convention will be used elsewhere throughout the specification. As camera 100 is generically enabled to acquire stereo images, apertures 123 are generally appreciated to be separated by a human interocular distance. Hence apertures 123 are separated by a distance in a range of approximately 58 mm to approximately 71 mm, however any suitable separation between apertures 123 is within the scope of present implementations. Indeed, apertures 123 can be separated by an average human interocular distance, in the range of about 62 mm to about 65 mm. Furthermore while in FIG. 1A, apertures 123 are depicted as being on a line parallel to a width of camera 100, in other implementation apertures 123 can be on a line parallel to a length of camera 100. However, the positioning of apertures 123 on camera 100 is not to be considered particularly limiting. Further housing 125 can comprise any suitable material (e.g. including but not limited to any suitable combination of plastic material and metal) and can be of any suitable shape; indeed, it is appreciated that housing 125 is not to be considered particularly limiting.

Attention is next directed to FIG. 2. It is appreciated that FIG. 2 is only one example of a structure of camera 100, and is not to be considered particularly limiting. Camera 100 further comprises a sensor 200 enabled to acquire electronic images from each of apertures 123, for example via a system of mirrors 201-1, 201-2, 203, wherein the system of minors 201, 203 are enabled to direct light from apertures 123 to sensor 200. Further, each of apertures 123 can comprise at least one lens (not depicted) for focussing light on respective minors 201. In some of these implementations, each lens can be controlled for depth of focus, and the like, via servo-motors, voice coil motors and the like.

In general, light travels from each of apertures 123 to respective minors 201 and sequentially reflects from minor 203 to sensor 200. Specifically, at least one of minors 201, 203 is generally enabled to change state for sequentially directing light from each of apertures 123 to sensor 200. In depicted implementations, mirror 203 is enabled to change state as will presently be explained. Minor 203 can be enabled to change state via a controller 204 for synchronizing sensor 200 with the state of minor 203, such that a first electronic image is acquired at sensor 200 from a first one of apertures 123 when minor 203 is in a first state and a second electronic image is acquired at sensor 200 from the other of apertures 123 when mirror 203 is in a second state.

Camera 100 can be any type of camera device that can be used to acquire digital images. Camera 100 can include, but is not limited to, any suitable combination of camera devices, digital cameras, digital SLR (single lens reflex) camera, computing devices, personal computers, laptop computers, portable electronic devices, mobile computing devices, portable computing devices, tablet computing devices, laptop computing devices, desktop phones, telephones, PDAs (personal digital assistants), cellphones, smartphones and the like. Other suitable camera devices are within the scope of present implementations.

Sensor 200 is generally enabled to acquire electronic images by way of light impinging on apertures 123 and light from apertures 123 travelling to sensor 200. Upon input from an input device 205, a processor 208 causes an image from sensor 200 to be captured and stored in a non-volatile storage 212. In some implementations camera 100 further comprises a mechanical shutter, including but not limited to single lens reflex shutter. However in other implementations, camera 100 comprises an electronic shutter.

Sensor 200 generally comprises a device for acquiring digital images, including but not limited one or more of a CMOS (Complementary metal-oxide-semiconductor) image sensor and a CCD (charge-coupled device) image sensor. However, any suitable device for acquiring digital images is within the scope of present implementations. While camera 100 can comprise further sensors, it is appreciated that in particular sensor 200 is enabled to sequentially acquire images from each of apertures 123.

Camera 100 further comprises at least one input device 205 generally enabled to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present implementations.

Input from input device 205 is received at processor 208 (which can be implemented as a plurality of processors, including but not limited to one or more central processing units (CPUs)). Processor 208 is configured to communicate with a non-volatile storage unit 212 (e.g. Erasable Electronic Programmable Read Only Memory (“EEPROM”), Flash Memory) and a volatile storage unit 216 (e.g. random access memory (“RAM”)). Programming instructions that implement the functional teachings of camera 100 as described herein are typically maintained, persistently, in non-volatile storage unit 212 and used by processor 208 which makes appropriate utilization of volatile storage 216 during the execution of such programming instructions. Those skilled in the art will now recognize that non-volatile storage unit 212 and volatile storage 216 are examples of computer readable media that can store programming instructions executable on processor 208. Furthermore, non-volatile storage unit 212 and volatile storage 216 are also examples of memory units and/or memory modules.

It is further appreciated that electronic images acquired at camera 100 can be stored at non-volatile storage 212, and hence non-volatile storage 212 comprises a memory for storing electronic images acquired by sensor 200. Alternatively, electronic images acquired by sensor 200 can be stored at one or memories external to camera 100, which can be one or more of local and remote to camera 100. When an external memory is used to store electronic images acquired by camera 100, camera 100 can further comprise an interface (not depicted) for accessing the external memory.

In some implementations, processor 208 comprises an image processor and/or an image processing engine. In other implementations, camera 100 further comprises one or more of an image processor and/or an image processing engine implemented at one or more second processors in communication with processor 208. Hence, processor 208 and/or the second processor and/or the image processor and/or the image processing engine can be further enabled to communicate with sensor 200 to receive images and/or a signal there from for processing and/or analysis.

In depicted implementations, processor 208 comprises controller 204, and processor 208 is in communication with sensor 200 and an apparatus 209 for changing the state of mirror 203. In other words, controller 204 is one or more of a software component and hardware component of processor 208.

However, in other implementations, controller 204 can be separate from processor 208, though in communication with processor 204. Indeed, a wide variety of configurations for controller 204 are contemplated, and controller 204 can be implemented in software, hardware, within processor 208 and/or separate from processor 208. Rather, the function of controller is to synchronize acquisition of images at sensor 200 with the state of mirror 203.

Further, processor 208 is in communication with sensor 200 and apparatus 209, such that controller 204 can change the state of mirror 203 in synchronization with sensor 200 when sequentially acquiring electronic images from apertures 123.

Processor 208 can be further configured to communicate with a display 224. Display 224 comprises any suitable one of or combination of CRT (cathode ray tube) and/or flat panel displays (e.g. LCD (liquid crystal display), plasma, OLED (organic light emitting diode), capacitive or resistive touchscreens, and the like). It is generally appreciated that display 224 comprises circuitry 290 that can be controlled, for example by processor 208, to render a representation 292 of data at display 224.

In some implementations, input device 205 and display 224 are external to camera 100, with processor 208 in communication with each of input device 205 and display 224 via a suitable connection and/or link.

In particular, it is appreciated that, when controller 204 is at least partially in software form, non-volatile storage 212 can store a copy of software components of controller 204 such that when processor 208 processes controller 204, processor 208 is enabled to synchronize acquisition of images at sensor 200 with a state of mirror 203.

It is further appreciated that processor 208 can store a camera application (not depicted) for operating camera 100, for example, to control camera 100 to acquire electronic images. In some implementations, controller 204 can comprise a module of the camera application. Further, upon processing the camera application, and/or controller 204, processor 208 can control circuitry 290 in display device 224 to render aspects of the camera application and/or controller 204 in representation 292.

In some implementations, camera 100 further comprises a communication device, and hence camera 100 can further comprise one or more communication interfaces (not depicted) for communicating with a communications network via any suitable wired and/or wireless protocol. Indeed, in some implementations sensor 200, apertures 123, minors 201, 203 and apparatus 209 can comprise a camera module in a communications device.

While not depicted, it is further appreciated that camera 100 further comprises a power source, including but not limited to a battery.

In any event, it should be understood that in general a wide variety of configurations for camera 100 are contemplated.

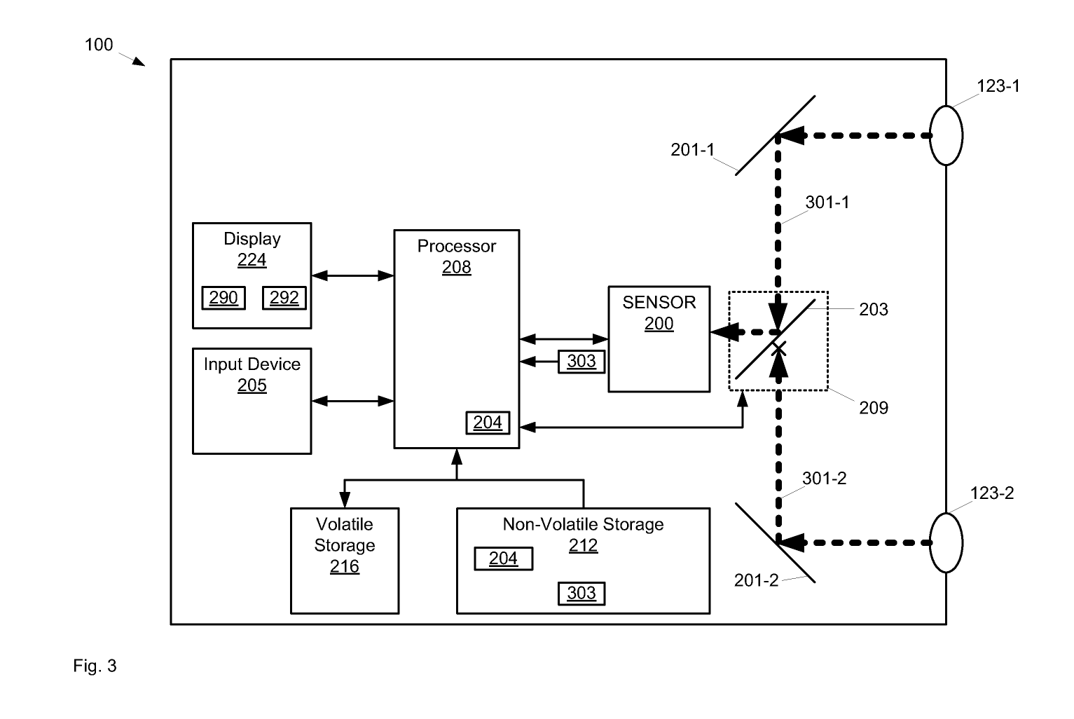

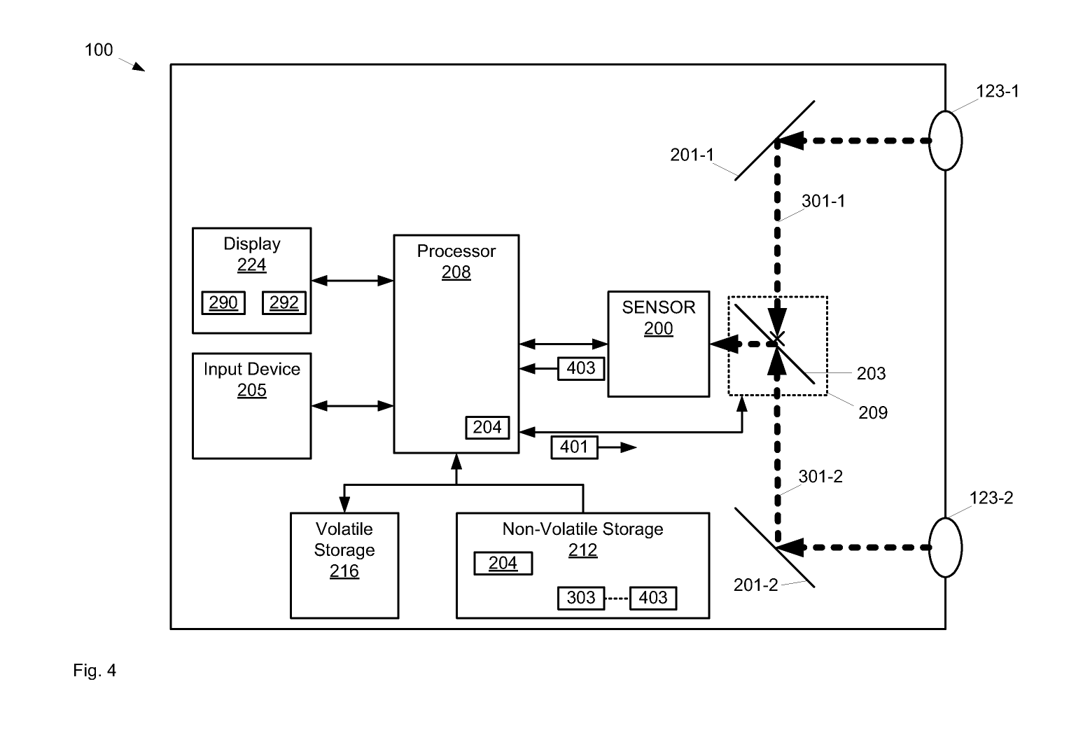

Acquisition of stereo images at camera 100 will now be described with reference to FIGS. 3 and 4, which are each similar to FIG. 2, with like elements having like numbers. It is appreciated that in FIG. 3, mirror 203 is in a first state and in FIG. 4, minor 203 is in a second state. Further, in implementations of FIGS. 3 and 4, mirror 203 is enabled to change state by one or more of rotating and moving from a first position to a second position. For example, minor 203 can comprise one or more of a prism device, a micromirror device, a digital micromirror device (DMD) and a microelectromechanical system (MEMS) device. Indeed, in these implementations, apparatus 209 can comprise any suitable device for rotating and/or moving minor 203 from the first position to the second position. In other words, apparatus 209 is enabled to change the state of minor 203 by changing the position of mirror 203. For example apparatus 209 can comprise one or more of servo-motor, a switch, a MEMS device and the like.

It is appreciated that, in these implementations, sensor 200 is located midway between apertures 123. Furthermore, respective mirrors 201 are located behind each of apertures 123 to direct light from respective apertures 123 to minor 203, while mirror 203 is located in front of sensor 200. Hence, each of minors 201 are enabled to reflect light from each respective apertures 123 by 90° to mirror 203 along respective paths 301-1, 301-2. However, in the first position, as depicted in FIG. 3, minor 203 directs light from aperture 123-1 and minor 201-1 to sensor 200, while light from aperture 123-2 is not directed to sensor 200, as represented by the “X” along path 301-2 in FIG. 3. For example, a backside of minor 203 can be absorbing and/or scattering, and hence in the first position light from aperture 123-2 can be absorbed and/or scattered. Alternatively, a backside of mirror 203 can be reflecting, and light from aperture 123-2 can be reflected away from sensor 200.

In any event, when minor 203 is in the first position, sensor 200 acquires a first image 303 from aperture 123-1, as synchronized by controller 204. Image 303 can be received at processor 208 and stored at non-volatile storage 212. Image 303 can be acquired after receiving input data at input device 205 indicating that stereo images are to be acquired at camera 100.

After acquiring image 303, controller 204 causes minor 203 to change states by moving mirror 203 from directing light from mirror 201-1to sensor 200 in the first state to directing light from mirror 201-2 in the second state. For example, controller 204 transmits a command 401 to apparatus 209 to rotate and/or move mirror 203 by 90° from the first position in FIG. 3 to the second position in FIG. 4. In the second position, mirror 203 directs light from mirror 201-2 (i.e. from aperture 123-2) to sensor 200, while light from aperture 123-1 is not directed to sensor 200, as represented by the “X” along path 301-1 in FIG. 4. When mirror 203 is in the second position, sensor 200 acquires a second image 403 from aperture 123-2, as synchronized by controller 204. Image 403 can be received at processor 208 and stored at non-volatile storage 212.

It is hence appreciated that images 303, 403 comprise sequential electronic images acquired by sensor 200 when mirror 203 is in the first state and the second state, and further images 303, 403 can be stored in association with each other, for example at non-volatile storage 212. Hence, as each of images 303, 403 are views from respective apertures 123, which are spaced by a human interocular distance, images 303, 403 can later viewed together as a stereo image using any suitable device for viewing stereo images.

It is further appreciated that switching minor 203 between the first state and the second state and acquiring associated stereo images 303, 403 at sensor 200 can occur within any suitable given time period. The given time period can be configured by processor 208 and/or controller 204 either automatically and/or upon receipt of input data at input device 205 indicative of a command to set the given time period. For example, the time period can be controlled to adjust for lighting, movement of features in view of apertures 123, sensitivity of sensor 200, and the like.

Further, while implementations are described in which image 303 is first acquired, in other implementations image 403 can be first acquired. Indeed, the order in which images 303, 403 are acquired, and hence the order in which mirror 203 is moved to each position, is generally non-limiting.

It should hence be apparent that a wide variety of configurations of mirrors are contemplated, with at least one mirror enabled to change state for sequentially directing light from each apertures 123 to sensor 200. In this manner, only one sensor can be used to acquire stereo images thereby reducing the cost of camera 100.

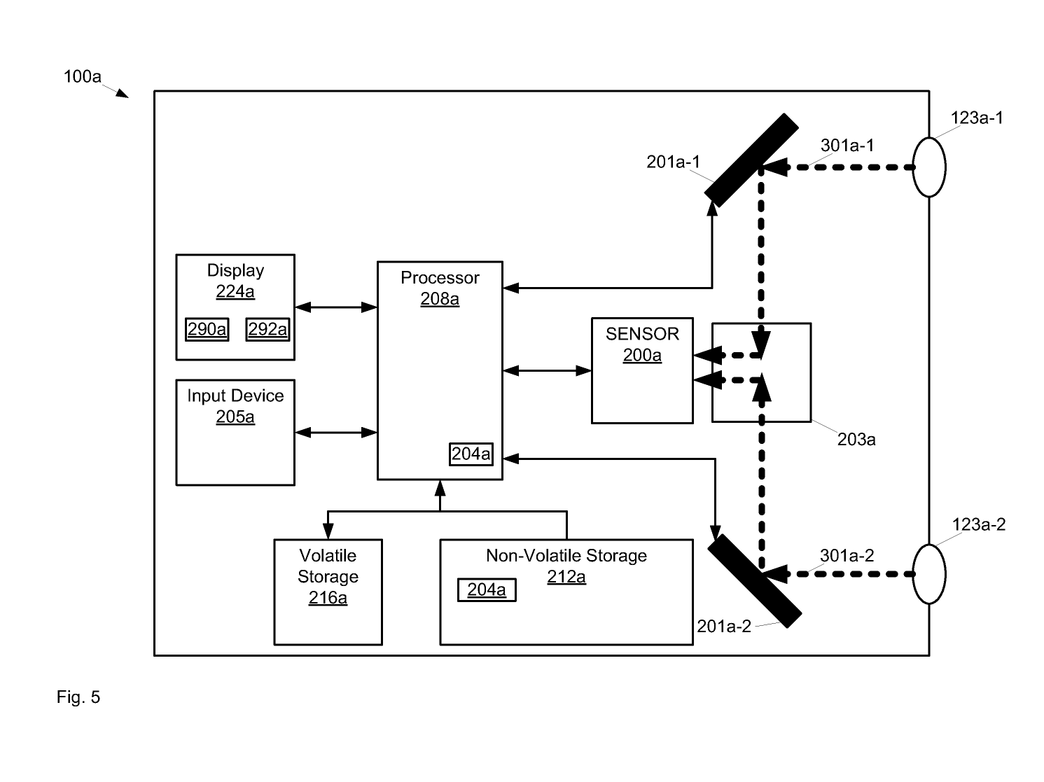

For example, while only mirror 203 is enabled to change state at camera 100, in other implementations, more than one mirror at camera 100 can be enabled to change state. For example, attention is directed to FIG. 5, which is substantially similar to FIG. 3, with like elements having like numbers, however with an “a” appended thereto. Hence, FIG. 5 depicts a camera 100a comprising, apertures 123a, sensor 200a, minors 201a, 203a, a controller 204a, an input device 205a, a processor 208a, non-volatile storage 212a (optionally storing a copy of controller 204a), and a display 224a comprising circuitry 290a to render a representation 292a.

However, in these implementations, minor 203a comprises a fixed state device enabled to simultaneously direct light from both of mirrors 201a, and hence corresponding apertures 123a, to sensor 200a along respective paths 301a. Mirror 203a can include, but is not limited to, a prismatic device, a minor system, a combination thereof, and the like. As depicted paths 301a don't overlap between mirror 203a and sensor 200a; however it is appreciated that this depiction is for clarity only and that paths 301a actually do overlap between mirror 203a and sensor 200a; indeed if an image were acquired with camera 100a as depicted in FIG. 5, sensor 200a would acquire one image composed of overlapping images from each of apertures 123a.

Further, each of minors 201a are enabled to change state for sequentially directing light from each of apertures 123a to sensor 200a. For example, each of minors 201a are enabled to change state by switching between a reflective state and a transmissive state. For example, each of mirrors 201a can comprise one or more of an electro-optic device and an electro-chromic device enabled to switch between a reflective state and a transmissive state. Alternatively, rather than transmissive state, each of minors 201a could be enabled to switch from a reflective state to an absorptive state.

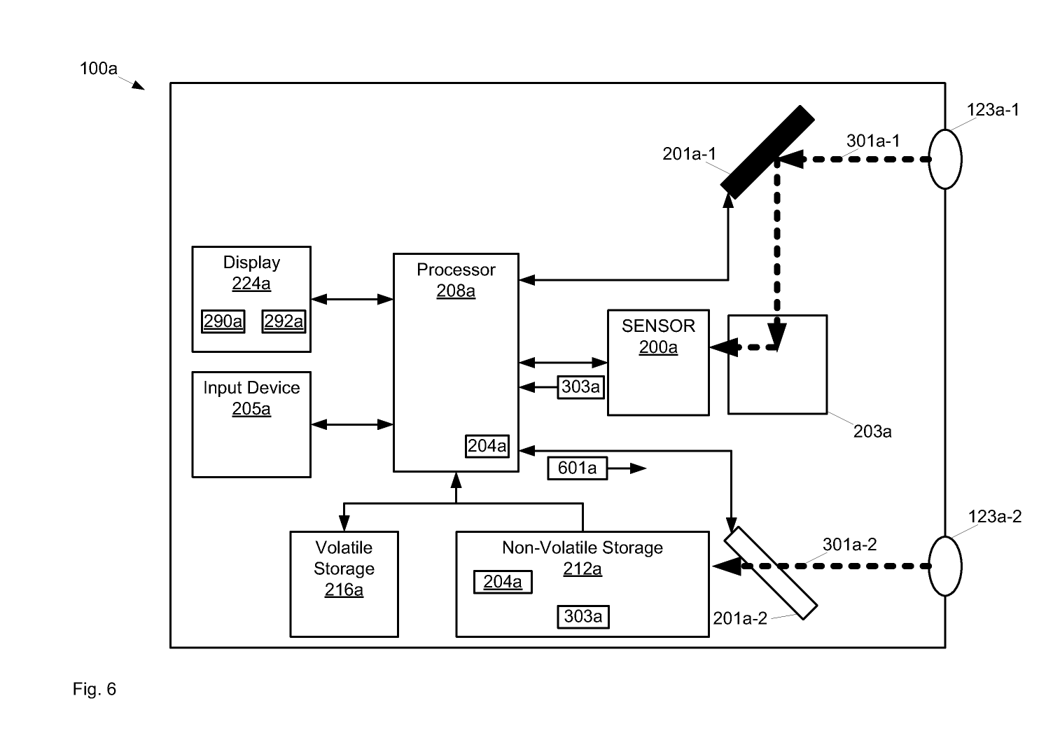

In FIG. 5, each of mirrors 201a is in a reflective state. Attention is next directed to FIG. 6 which is substantially similar to FIG. 5 with like elements having like numbers. However, in FIG. 6, controller 204a transmits a command 601a to mirror 201a-2 to control minor 201a-2 to a transmissive state. Alternatively, mirror 201a-2 can initially be in a transmissive state thereby obviating command 601a.

In any event, when minor 201a-2 is in a transmissive state, light from aperture 123a-2, following path 301a-2, is not reflected to minor 203a, but rather passes through minor 201a-2 to be absorbed and/or scattered.

However, minor 201a-1 is in a reflective state and hence light from aperture 123a-1 is reflected to mirror 203a which directs the light to sensor 200a, where an image 303a is acquired for storage in a memory such as non-volatile storage 212a.

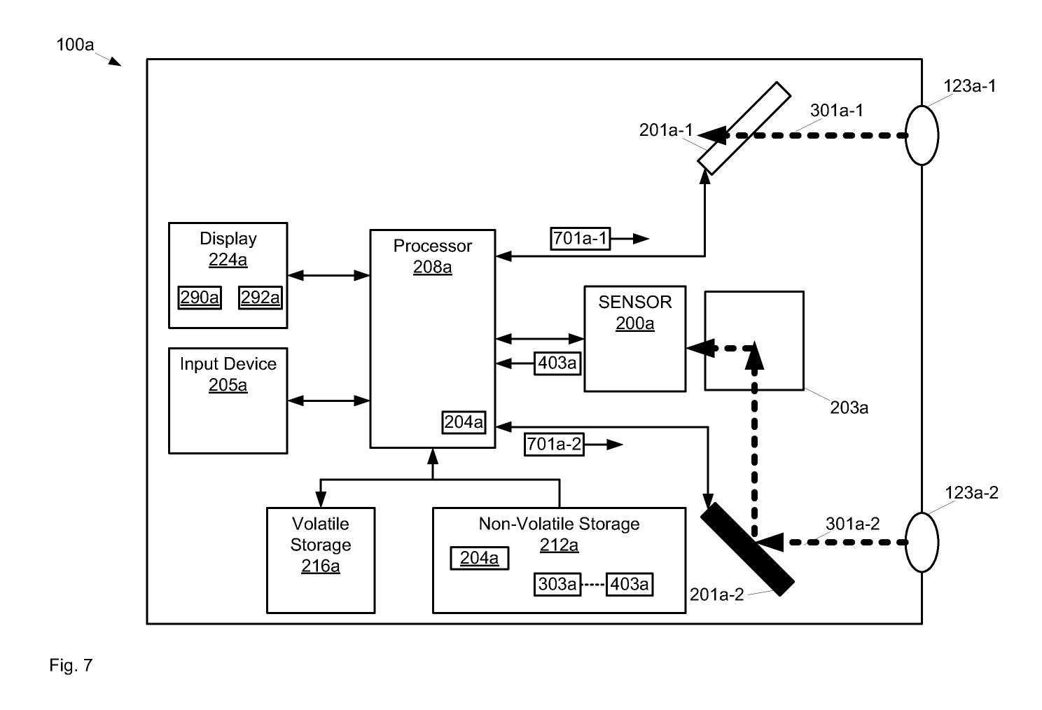

Attention is next directed to FIG. 7which is substantially similar to FIG. 6 with like elements having like numbers. However, in FIG. 7, controller 204a transmits a command 701a-1 to control mirror 201a-1 to a transmissive state, and a command 701a-2 to control mirror 201a-2 to a reflective state. Hence, when minor 201a-1 is in a transmissive state, light from aperture 123a-1, following path 301a-1, is not reflected to mirror 203a, but rather passes through mirror 201a-1 to be absorbed and/or scattered. However, mirror 201a-2 is in a reflective state and hence light from aperture 123a-2 is directed to minor 203a, which directs the light to sensor 200a which acquires image 403a for storage in a memory such as non-volatile storage 212a in association with image 303a, as synchronized by controller 204a.

It is hence appreciated that images 303a, 403a comprise sequential electronic images acquired by sensor 200a when minors 201a are in the first state and the second state, and further images 303a, 403a can be stored in association with each other, for example at non-volatile storage 212a. Hence, as each of images 303a, 403a are views from respective apertures 123a, which are spaced by a human interocular distance, images 303a, 403a can be later viewed together as a stereo image using any suitable device for viewing stereo images.

While minors 201a are enabled to change states by changing between a reflective state and a transmissive state, in other implementations, each of mirrors 201a can be reflective, similar to mirrors 201, but enabled to be moved and/or rotated between positions, similar to mirror 201.

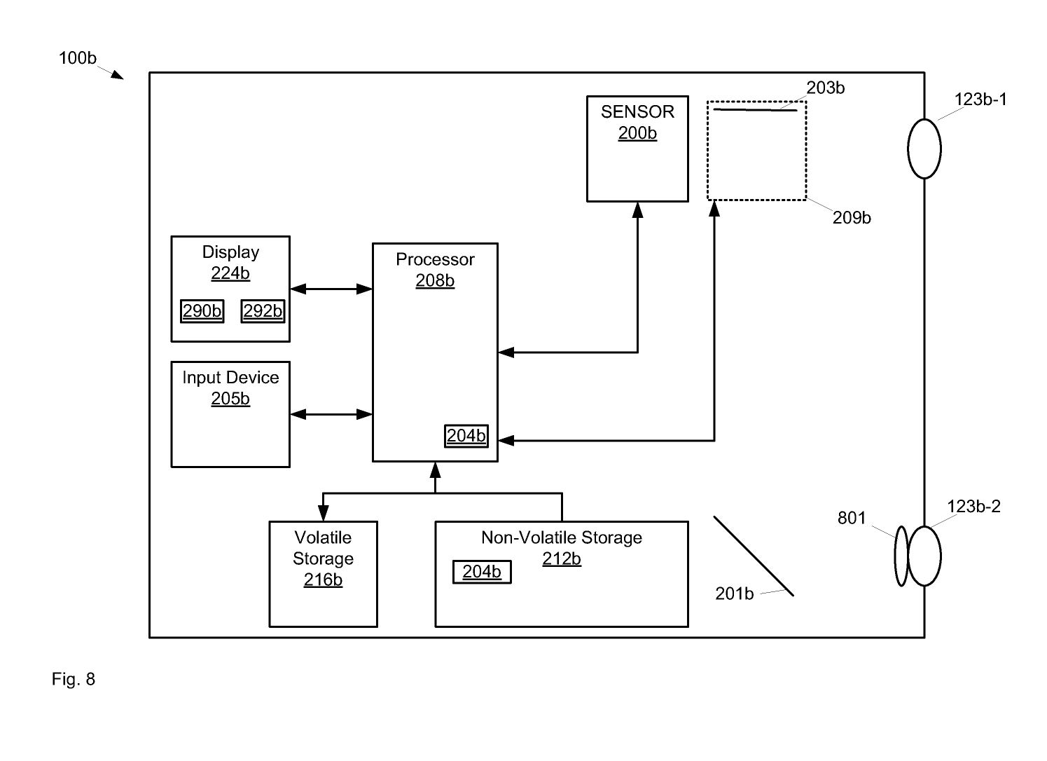

Attention is next directed to FIG. 8, which is substantially similar to FIG. 1, with like elements having like numbers, however with a “b” appended thereto. Hence, FIG. 8 depicts a camera 100b comprising, apertures 123b, sensor 200b, mirrors 201b, 203b, a controller 204b, an input device 205b, a processor 208b, apparatus 209b, non-volatile storage 212b (optionally storing a copy of controller 204b), and a display 224b comprising circuitry 290b to render a representation 292b.

In contrast to camera 100, at camera 100b, sensor 200b is located behind a given one of the two apertures 123. As depicted sensor 200b is located behind aperture 123b-1. However, in other implementations, sensor 200b could be located behind aperture 123b-2.

Mirror 203b is located between aperture 123b-1 and sensor 200b, and mirror 201b is located behind aperture 123b-2 to direct light there from to minor 203b.

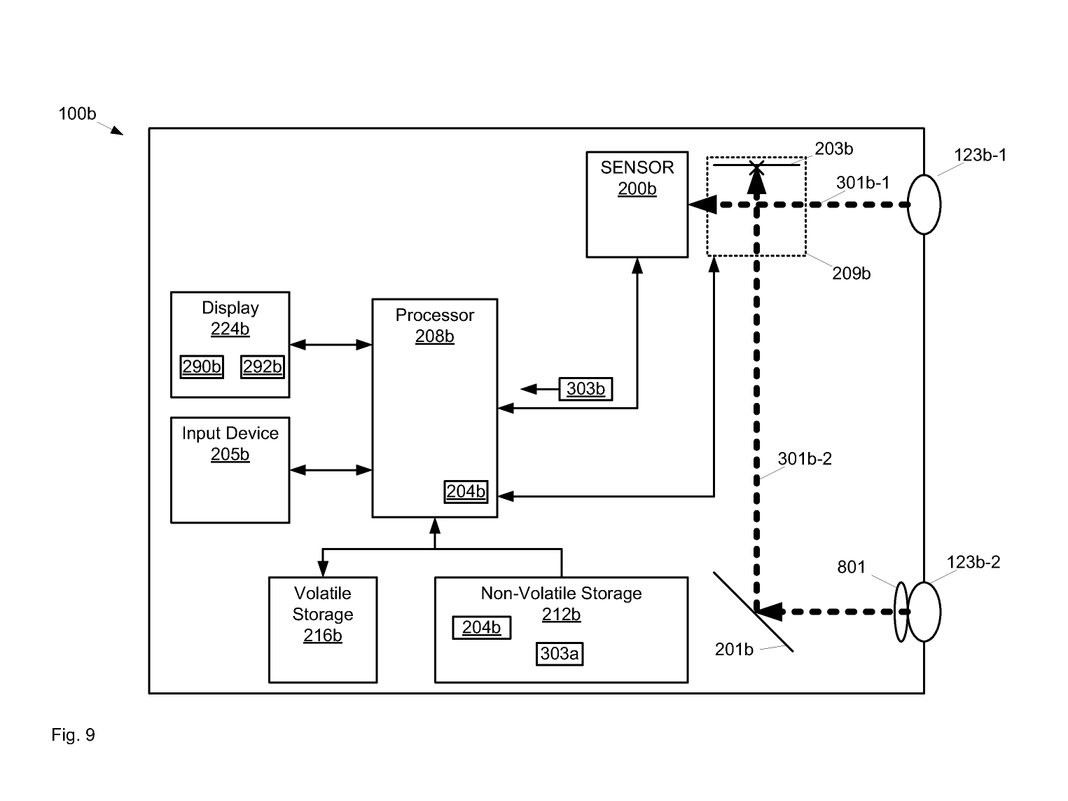

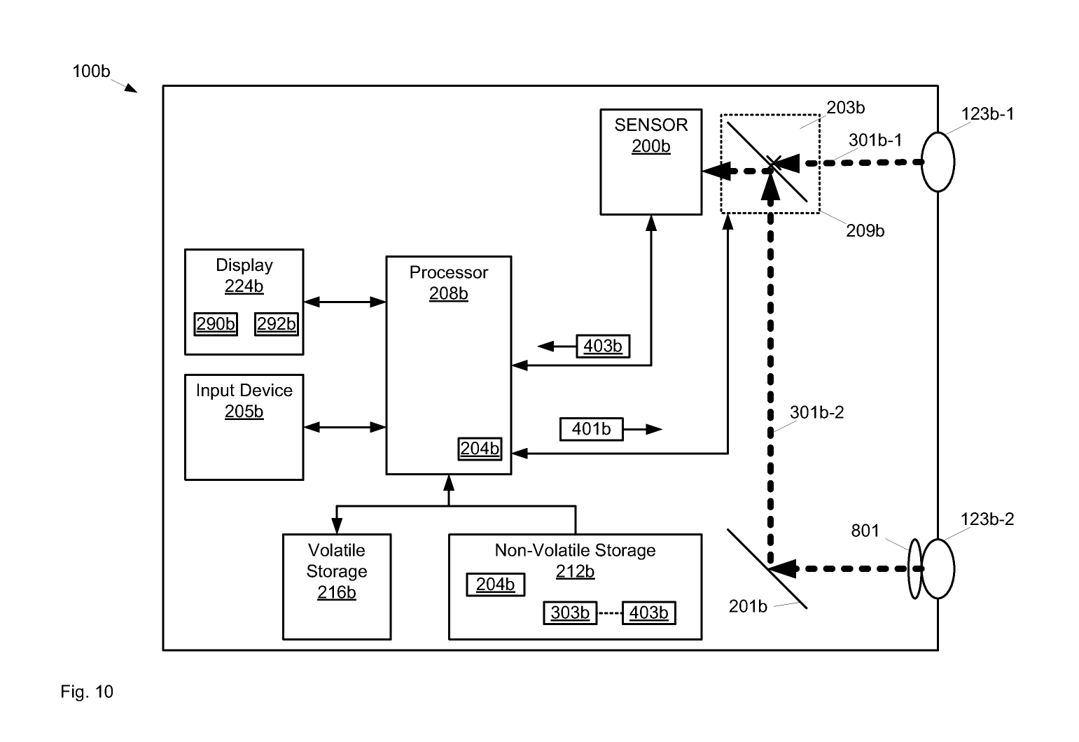

With reference to FIGS. 9 and 10, each of which are substantially similar to FIG. 8 with like elements having like number, minor 203b is generally enabled to change states by moving between being out of a path 301b-1 between aperture 123b-1 and sensor 200b in the first state, as depicted in FIG. 9, to being in path 301b-1 to direct light from aperture 123b-2 and mirror 201b to sensor 200b in the second state, along path 301b-2, as depicted in FIG. 10.

Indeed, it is appreciated that image 303b is acquired from aperture 123b-1 when minor 203b is in the first state in FIG. 9. Then, as depicted in FIG. 10, controller 204b controls apparatus 209b, via command 401b, to move mirror 203b into path 301b-1 thereby blocking light from aperture 123b-1. This enables light from aperture 213b-2 to travel along path 301b-2 to sensor 200b, thereby reflecting light from aperture 123b-2 to sensor 200b which acquires image 403b, as synchronized by controller 204b.

While implementations have been described with reference to minor 203b initially being out of path 301b-1 such that image 303b is first acquired, in other implementations the order of acquisition of images 303b, 403b can be reversed, with minor 203b initially being in the position of FIG. 10. Indeed, the order in which images 303b, 403b is appreciated to be generally non-limiting.

It is hence appreciated that images 303b, 403b comprise sequential electronic images acquired by sensor 200b when mirror 203b is in the first state and the second state, and further images 303b, 403b can be stored in association with each other, for example at non-volatile storage 212b. Hence, as each of images 303b, 403b are views from respective apertures 123b, which are spaced by a human interocular distance, images 303b, 403b can later viewed together as a stereo image using any suitable device for viewing stereo images.

In some implementations, as depicted FIGS. 8 to 10, camera 100b further comprises a lens 801 at aperture 123b-2 to correct for a difference in path length from each of apertures 123b to sensor 200b. In other words, as path 301b-1 and 301b-2 are of different lengths, each will have slightly different focal points; lens 801 corrects for this path length difference. In other implementations, a suitable lens could be at aperture 123b-1. In implementations where one or more of apertures 123b already comprise a lens, the one or more lenses can be configured to correct for the path length difference.

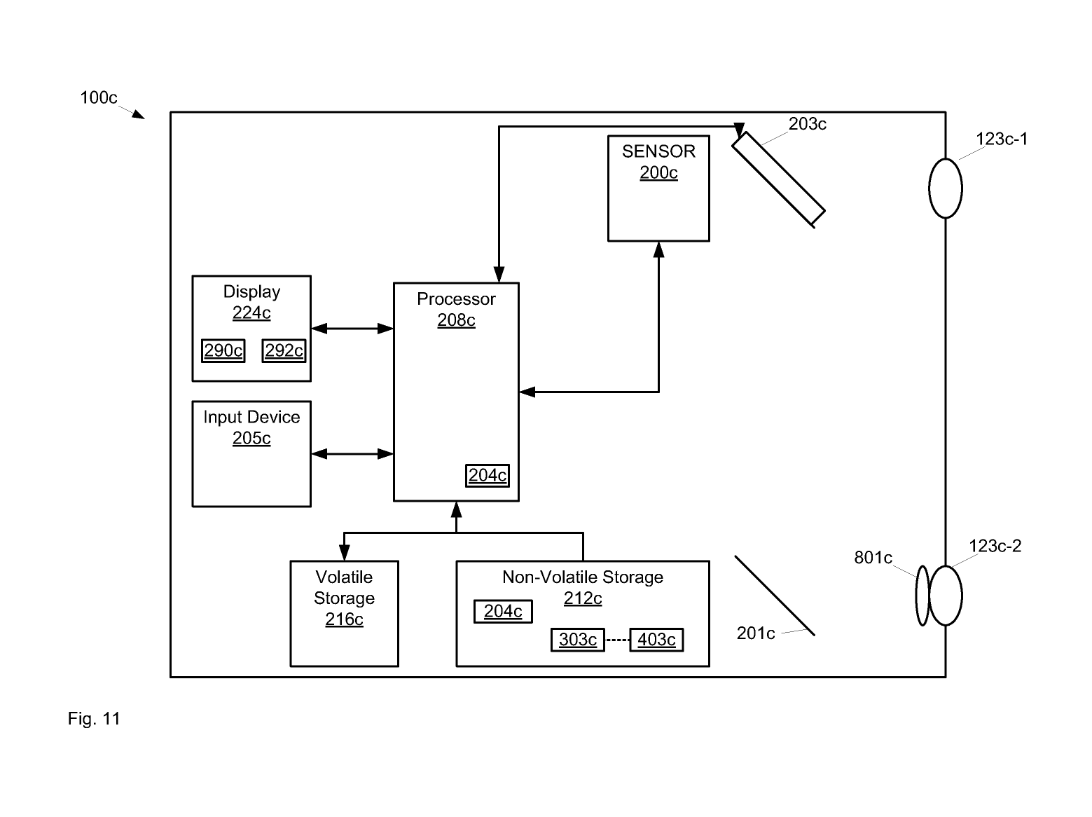

Attention is next directed to FIGS. 11 to 13, each of which are substantially similar to FIG. 8, with like elements having like numbers, however with a “c” appended thereto rather than a “b”. Hence, FIGS. 11 to 13 each depict a camera 100c comprising, apertures 123c, sensor 200c, mirrors 201c, 203c, a controller 204c, an input device 205c, a processor 208c, non-volatile storage 212c (optionally storing a copy of controller 204c), a display 224c comprising circuitry 290c to render a representation 292c, and optionally a lens 801c.

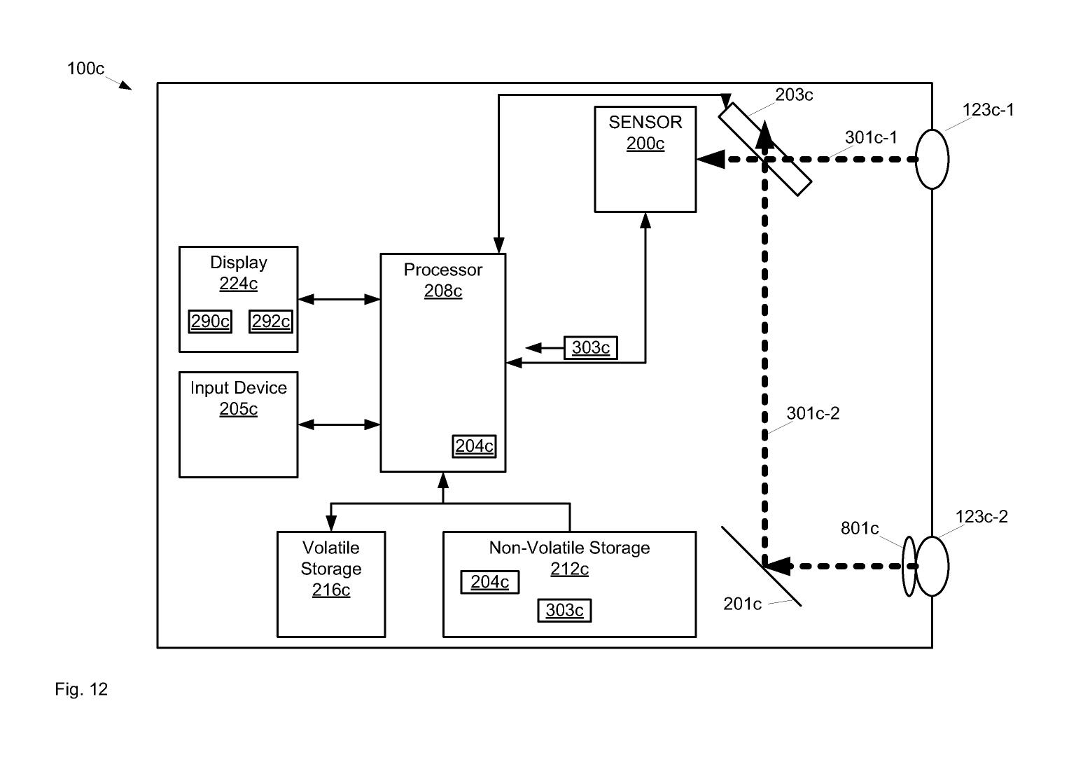

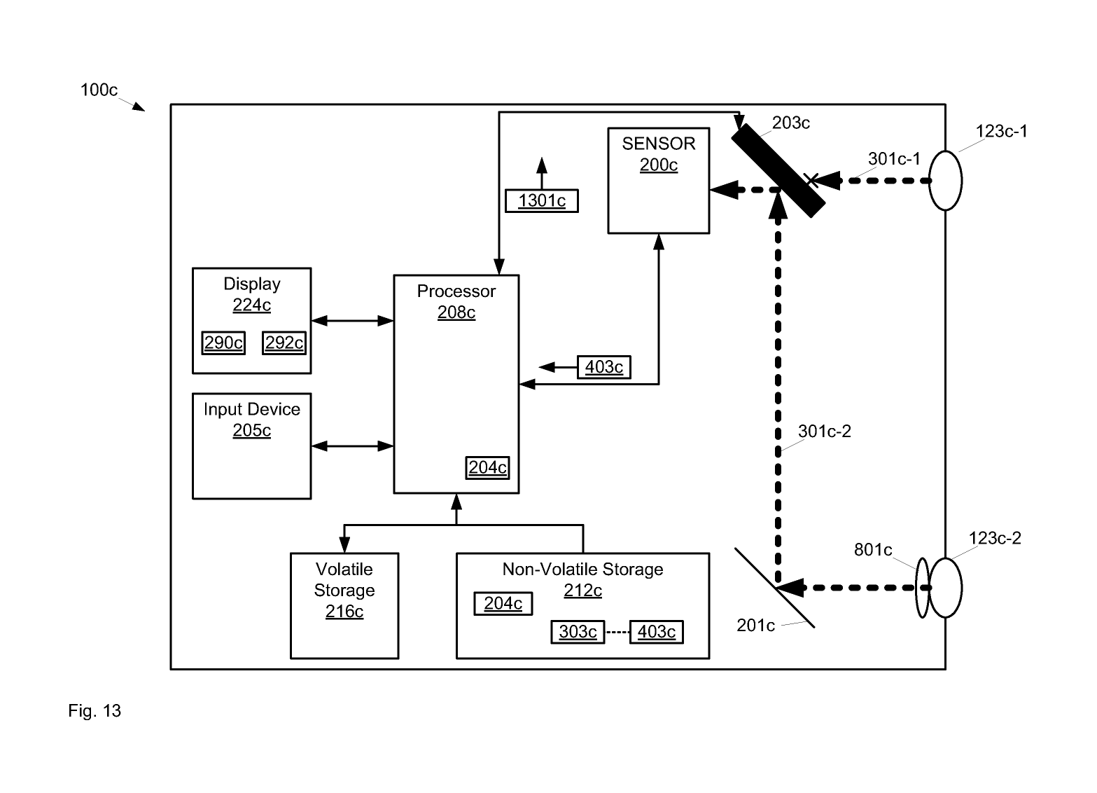

Camera 100c differs from camera 100b in that minor 203c is similar to minors 201a and is enabled to change between a transmissive state, such that the light from aperture 123c-1 is directed through mirror 203c to sensor 200c in the first state, as depicted in FIG. 12, and a reflective state to direct light from aperture 123c-2 and mirror 201c to sensor 200c in the second state as depicted in FIG. 13.

In other words, in FIG. 12, when minor 203c is in a transmissive state, light from aperture 123c-1 passes through mirror 203c along path 301c-1, and light from aperture 123c-2 passes through mirror 203c to be absorbed and/or scattered. Image 303c is acquired at sensor 200c.

Then, as depicted in FIG. 13, and as synchronized by controller 204c via a command 1301c, mirror 203c changes to a reflective state, thereby preventing light from aperture 123c-1 from reaching sensor 200c, but reflecting light from aperture 123c-2 and minor 201c to sensor 200c, such that image 403c is acquired.

Again, the order in which images 303c and 403c is immaterial and minor 203c can start in a reflective state and be controlled to a transmissive state.

It is hence appreciated that images 303c, 403c comprise sequential electronic images acquired by sensor 200c when minor 203c is in the first state and the second state, and further images 303c, 403c can be stored in association with each other, for example at non-volatile storage 212c. Hence, as each of images 303c, 403c are views from respective apertures 123c, which are spaced by a human interocular distance, images 303c, 403c can later viewed together as a stereo image using any suitable device for viewing stereo images.

Further, using a mirror that can change between states to direct light from each of two apertures in a camera to a single sensor, the cost of cameras for producing stereo images can be substantially reduced.

Those skilled in the art will appreciate that in some implementations, the functionality of camera 100, 100a, 100b, 100c can be implemented using pre-programmed hardware or firmware elements (e.g., application specific integrated circuits (ASICs), electrically erasable programmable read-only memories (EEPROMs), etc.), or other related components. In other implementations, the functionality of camera 100, 100a, 100b, 100c can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

A portion of the disclosure of this patent document contains material which is subject to copyright protection. The copyright owner has no objection to the facsimile reproduction by any one of the patent document or patent disclosure, as it appears in the Patent and Trademark Office patent file or records, but otherwise reserves all copyrights whatsoever.

Persons skilled in the art will appreciate that there are yet more alternative implementations and modifications possible, and that the above examples are only illustrations of one or more implementations. The scope, therefore, is only to be limited by the claims appended hereto.

What is claimed is:

1. A camera device comprising:
two apertures in a housing of the camera device, the two apertures separated by a human interocular distance;
a sensor for sequentially acquiring electronic images from each of the two apertures;
at least one mirror enabled to change state for sequentially directing light from each of the two apertures to the sensor; and
a controller for synchronizing the sensor with the state of the at least one mirror such that a first electronic image is acquired at the sensor from a first one of the two apertures when the at least one minor is in a first state and a second electronic image is acquired at the sensor from the other of the two apertures when the at least one mirror is in a second state.

2. The camera device of claim 1, wherein the two apertures are separated by a distance in a range of approximately 58 mm to approximately 71 mm.

3. The camera device of claim 1, wherein the sensor comprises a CMOS (Complementary metal-oxide-semiconductor) image sensor or a CCD (charge-coupled device) image sensor.

4. The camera device of claim 1, further comprising a system of mirrors for directing light from the two apertures to the sensor, wherein the system of mirrors comprises the at least one mirror.

5. The camera device of claim 1, wherein the at least one mirror is enabled to change the state by one or more of rotating and moving from a first position to a second position.

6. The camera device of claim 5, wherein the at least one mirror comprises one or more of a prism device, a micromirror device, a digital micromirror device (DMD) and a microelectromechanical system (MEMS) device.

7. The camera device of claim 1, wherein the sensor is located midway between the two apertures.

8. The camera device of claim 7, further comprising respective mirrors behind each of the two apertures to direct the light to the at least one mirror, the at least one mirror located in front of the sensor.

9. The camera device of claim 8, wherein the at least one mirror is enabled to change states by moving from directing the light from a first one of the respective minors to the sensor in the first state to directing the light from a second one of the respective minors in the second state.

10. The camera device of claim 1, wherein the at least one mirror is enabled to change the state by switching between a reflective state and a transmissive state.

11. The camera device of claim 10, wherein the at least one mirror comprises one or more of an electro-optic device and an electro-chromic device.

12. The camera device of claim 1, wherein the sensor is located behind a given one of the two apertures.

13. The camera device of claim 12, further comprising a second minor located behind the other of the two apertures to direct the light to the at least one minor, the at least one minor between the sensor and the given one of the two apertures.

14. The camera device of claim 13, wherein the at least one mirror is enabled to change states moving between being out of a path between the given one of the two apertures and the sensor in the first state, and into the path to direct the light from the other of the two apertures and the second minor to the sensor in the second state.

15. The camera device of claim 12, further comprising a lens at one of the two apertures to correct for a difference in path length from each of the two apertures to the sensor.

16. The camera device of claim 12, wherein the at least one mirror is enabled to change states by changing between a transmissive state, such that the light from the given one of the apertures is directed from the given one of the apertures through the at least one minor to the sensor in the first state, and a reflective state such that light from other of the two apertures and the second minor is directed to the sensor in the second state.

17. The camera device of claim 1, further comprising an apparatus for changing the state of the at least one mirror by changing position of the at least one minor.

18. The camera device of claim 1, further comprising a processor, which in turn comprises the controller, the processor in communication with the sensor and an apparatus for changing the state of the at least one mirror.

19. The camera device of claim 1, further comprising a memory for storing the electronic images acquired by the sensor.

20. The camera device of claim 1, wherein sequential electronic images acquired by the sensor when the at least one mirror is in the first state and the second state are stored in association with each other such that they can be later viewed as a stereo image.
